(19) United States
(12) Patent Application Publication
(10) Pub. No.: US 2024/0253352 A1
(43) Pub. Date: Aug. 1, 2024

(54) FLOW PATH UNIT, METHOD OF MANUFACTURING FLOW PATH UNIT, AND LIQUID EJECTING APPARATUS

(71) Applicant: SEIKO EPSON CORPORATION, Tokyo (JP)

(72) Inventors: Satoshi SHIRAI, MATSUMOTO-SHI (JP); Taro TAKEKOSHI, SHIOJIRI-SHI (JP)

(21) Appl. No.: 18/414,006

(22) Filed: Jan. 16, 2024

(30) Foreign Application Priority Data
Jan. 17, 2023 (JP) 2023-005112

(51) Int. Cl. B41J 2/14; B41J 2/16

(52) U.S. Cl. CPC B41J 2/14; B41J 2/16

(57) ABSTRACT

the flow path unit including: a flow path base material absorbent to laser light; and a flow path member that is transparent to laser light and is welded to the flow path base material, the flow path base material has a first surface and a second surface, a welding region to be welded to the flow path member is formed at the first surface, a relay flow path that is a portion of a flow path is defined by welding the flow path member to the welding region, the flow path member has a welding surface welded to the welding region, an opposite surface that is a surface opposite to the welding surface, and a coupling pipe that extends from the opposite surface, a coupling flow path that is a portion of the flow path opens in the coupling pipe, the coupling flow path communicates with the relay flow path.

The present application is based on, and claims priority from JP Application Serial Number 2023-005112, filed Jan. 17, 2023, the disclosure of which is hereby incorporated by reference herein in its entirety.

### BACKGROUND

### 1. Technical Field

The present disclosure relates to a flow path unit, a method of manufacturing the flow path unit, and a liquid ejecting apparatus.

### 2. Related Art

JP-A-2005-297453 discloses a flow path unit that constitutes a flow path through which a liquid flows. The flow path unit includes a flow path base material and a film welded to the flow path base material. By welding the film to the flow path base material, a portion of the flow path is defined by the flow path base material and the film. The flow path unit includes a coupling pipe through which a flow path opens.

In the flow path unit disclosed in JP-A-2005-297453, the coupling pipe is located to extend from a surface opposite to the surface defining a portion of the flow path in the flow path base material. This is because when a portion of the flow path is defined by the film, it is difficult to locate the coupling pipe to extend from a surface defining the portion of the flow path in the flow path base material. In the flow path base material, when the coupling pipe is located to extend from a surface opposite to the surface defining the portion of the flow path, the flow path tends to be longer than when the coupling pipe is located to extend from a surface defining the portion of the flow path. Therefore, pressure loss in the flow path tends to increase.

### SUMMARY

According to an aspect of the present disclosure, there is provided a flow path unit that constitutes a flow path through which a liquid flows, the flow path unit including: a flow path base material absorbent to laser light; and a flow path member that is a plate material transparent to laser light and is welded to the flow path base material, in which the flow path base material has a first surface and a second surface that is a surface opposite to the first surface, a welding region to be welded to the flow path member is formed at the first surface, a relay flow path that is a portion of the flow path is defined by welding the flow path member to the welding region, the flow path member has a welding surface that is welded to the welding region, an opposite surface that is a surface opposite to the welding surface, and a coupling pipe that extends from the opposite surface, a coupling flow path that is a portion of the flow path opens in the coupling pipe, and the coupling flow path communicates with the relay flow path.

According to another aspect of the present disclosure, there is provided a liquid ejecting apparatus including: a head that ejects a liquid; and a flow path unit that constitutes a flow path through which a liquid supplied to the head flows, in which the flow path unit has a flow path base material absorbent to laser light, and a flow path member that is a plate material transparent to laser light and is welded to the flow path base material, the flow path base material has a first surface and a second surface that is a surface opposite to the first surface, a welding region to be welded to the flow path member is formed at the first surface, a relay flow path that is a portion of the flow path is defined by welding the flow path member to the welding region, the flow path member has a welding surface welded to the welding region, an opposite surface that is a surface opposite to the welding surface, and a coupling pipe that extends from the opposite surface, a coupling flow path that is a portion of the flow path opens in the coupling pipe, and the coupling flow path communicates with the relay flow path.

According to still another aspect of the present disclosure, there is provided a method of manufacturing a flow path unit including a flow path base material and a flow path member, the flow path base material being absorbent to laser light and having a first surface and a second surface that is a surface opposite to the first surface, the flow path member being a plate material transparent to laser light and having a welding surface, an opposite surface opposite to the welding surface, and a coupling pipe that extends from the opposite surface and has a coupling flow path opened, the method including: bringing the welding surface into contact with the first surface; and welding the flow path member to the flow path base material such that a relay flow path communicating with the coupling flow path is defined by irradiating a welding region, which is a region in contact with the welding surface on the first surface, with laser light.

### BRIEF DESCRIPTION OF THE DRAWINGS

FIG. 1 is a front view illustrating an embodiment of a liquid ejecting apparatus including a flow path unit.

FIG. 2 is a perspective view of a coupling section.

FIG. 3 is a perspective view of the coupling section in a state where an upstream coupling body is removed.

FIG. 4 is a top view of the coupling section.

FIG. 5 is a perspective view of the flow path unit.

FIG. 6 is a top view of the flow path unit.

FIG. 7 is a bottom view of the flow path unit.

FIG. 8 is a top view of a flow path base material.

FIG. 9 is a bottom view of the flow path base material.

FIG. 10 is a cross-sectional view taken along line X-X in FIG. 4.

FIG. 11 is an exploded perspective view of the flow path unit.

FIG. 12 is an enlarged view of FIG. 11.

FIG. 13 is a cross-sectional view of a state where a second relay flow path is closed.

FIG. 14 is a perspective view of a state where a protective plate is attached.

FIG. 15 is a perspective view of a state where an operation plate and an operation pin are attached.

FIG. 16 is a perspective view of a state where a pressing plate is attached.

FIG. 17 is a perspective view before a slider is attached.

FIG. 18 is a perspective view after the slider is attached.

FIG. 19 is a flowchart illustrating a method of manufacturing a flow path unit.

FIG. 20 is a cross-sectional view illustrating a modification example of the flow path unit.

### DESCRIPTION OF EMBODIMENTS

One embodiment of a liquid ejecting apparatus including a flow path unit will be described below with reference to the drawings. The liquid ejecting apparatus is an ink jet printer that prints images such as characters and photographs by ejecting ink, which is an example of a liquid, onto a medium such as paper or cloth.

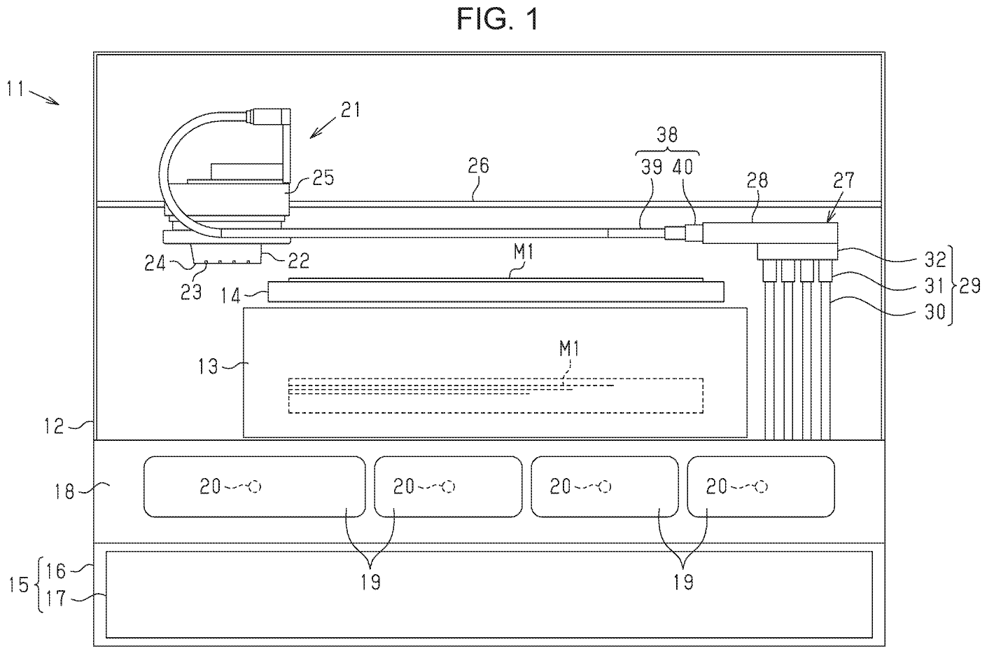

As illustrated in FIG. 1, a liquid ejecting apparatus 11 includes a housing 12.

The liquid ejecting apparatus 11 includes a medium accommodating body 13. The medium accommodating body 13 is configured to accommodate a medium M1. The medium accommodating body 13 is mounted in the housing 12. In one example, the medium accommodating body 13 is a cassette detachable from the housing 12.

The liquid ejecting apparatus 11 includes a support section 14. The support section 14 supports the medium M1. Specifically, the support section 14 supports the medium M1 supplied from the medium accommodating body 13. The medium M1 is transported from the medium accommodating body 13 toward the support section 14.

The liquid ejecting apparatus 11 may include one or a plurality of expansion units 15. The expansion unit 15 is attached to the housing 12. The expansion unit 15 is arranged below the housing 12. The expansion unit 15 has an expansion frame 16 and an expansion accommodating body 17. The expansion accommodating body 17 is configured to accommodate the medium M1. The expansion accommodating body 17 is mounted to the expansion frame 16. The expansion accommodating body 17 is a cassette detachable from the housing 12.

The liquid ejecting apparatus 11 includes a mounting section 18. The mounting section 18 is configured such that one or more liquid accommodating bodies 19 can be mounted thereon. In one example, four liquid accommodating bodies 19 are mounted on the mounting section 18. The liquid accommodating body 19 is a container that accommodates a liquid. The liquid accommodating body 19 is, for example, an ink pack. The four liquid accommodating bodies 19 each accommodate a different type of liquid. In one example, the four liquid accommodating bodies 19 each accommodate color inks of different colors. The four liquid accommodating bodies 19 may each accommodate the same type of liquid.

The mounting section 18 has one or more liquid introduction sections 20. In one example, the mounting section 18 has four liquid introduction sections 20. The liquid introduction section 20 is coupled to the liquid accommodating body 19 by mounting the liquid accommodating body 19 on the mounting section 18. The liquid introduction section 20 introduces a liquid from the liquid accommodating body 19 to a printing section 21, which will be described later. The liquid introduction section 20 includes a coupling needle coupled to the liquid accommodating body 19, a pump sending the liquid from the liquid accommodating body 19 to the printing section 21, and the like.

The liquid ejecting apparatus 11 includes the printing section 21. The printing section 21 is configured to perform printing on the medium M1 by ejecting a liquid onto the medium M1. The printing section 21 ejects a liquid onto the medium M1 supported by the support section 14.

The printing section 21 has a head 22. The head 22 is configured to eject a liquid. The head 22 has a nozzle surface 24 in which one or more nozzles 23 are open. The nozzle surface 24 faces the support section 14. The head 22 ejects the liquid from the nozzle 23 onto the medium M1 supported by the support section 14.

The printing section 21 may have a carriage 25 and a guide shaft 26. The head 22 is mounted on the carriage 25. The carriage 25 is supported by the guide shaft 26. The carriage 25 moves along the guide shaft 26. Accordingly, the carriage 25 scans the medium M1. In this way, the liquid ejecting apparatus 11 is a serial printer. The liquid ejecting apparatus 11 may be a line printer capable of ejecting a liquid all at once across the entire width of the medium M1.

The liquid ejecting apparatus 11 includes a coupling section 27. The coupling section 27 is configured to couple the mounting section 18 and the printing section 21 to each other. The liquid is supplied from the mounting section 18 to the printing section 21 through the coupling section 27.

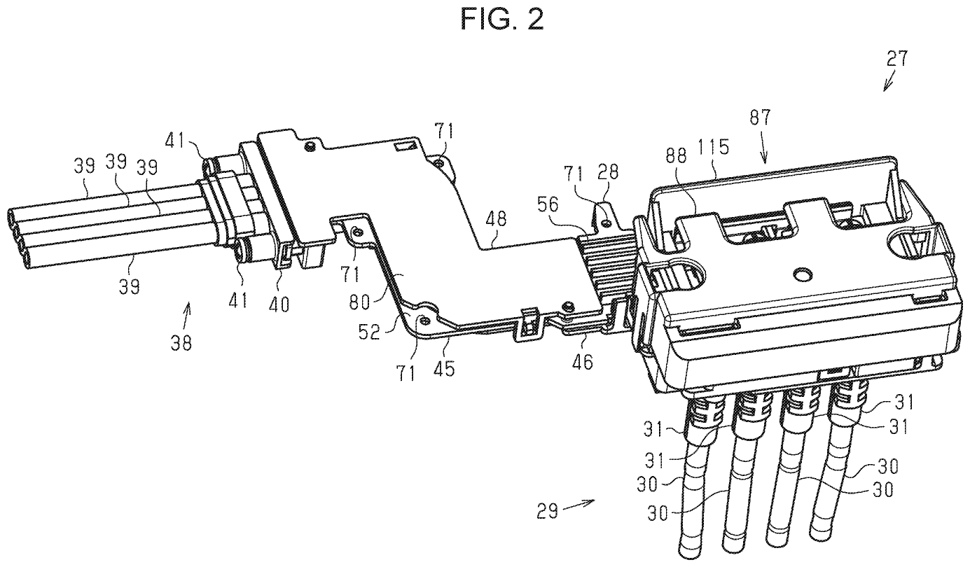

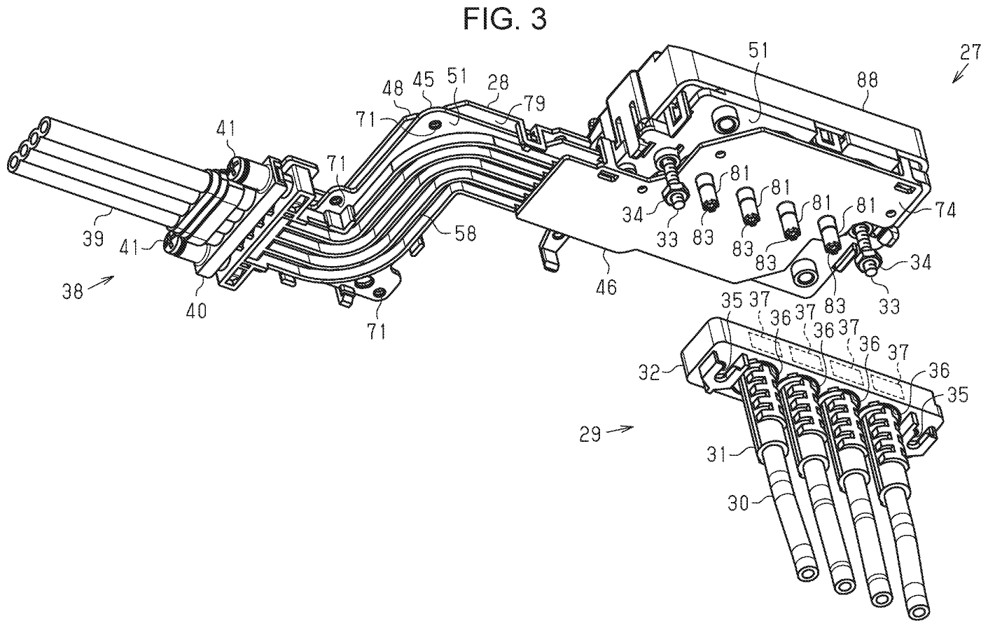

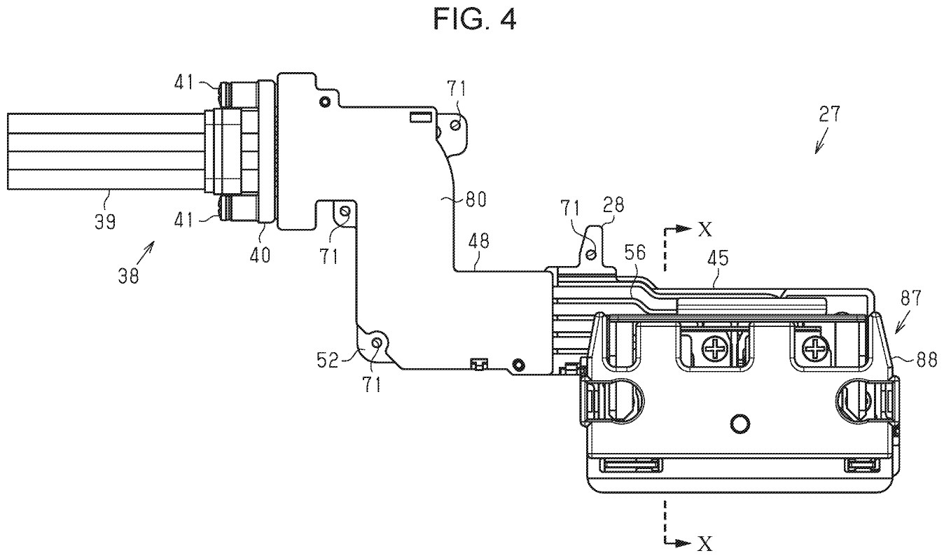

As illustrated in FIGS. 2, 3, and 4, the coupling section 27 has a flow path unit 28. The flow path unit 28 is a unit manufactured by laser welding. As the liquid flows in the flow path unit 28, the liquid is supplied from the mounting section 18 to the printing section 21. The flow path unit 28 will be described in detail later.

The coupling section 27 has an upstream coupling body 29. The upstream coupling body 29 is coupled to the mounting section 18 and the flow path unit 28. The upstream coupling body 29 has one or more upstream pipes 30. The upstream pipe 30 is coupled to the liquid introduction section 20 and the flow path unit 28. In one example, the upstream coupling body 29 has four upstream pipes 30. The four upstream pipes 30 are coupled to the four liquid accommodating bodies 19, respectively. The upstream pipe 30 is, for example, a tube.

The upstream coupling body 29 may have one or more upstream coupling members 31. In one example, the upstream coupling body 29 has four upstream coupling members 31. The upstream coupling member 31 is attached to a tip of the upstream pipe 30. The upstream pipe 30 is coupled to the flow path unit 28 by coupling the upstream coupling member 31 to the flow path unit 28. The upstream pipe 30 may be directly coupled to the flow path unit 28.

The upstream coupling body 29 may have an upstream joint 32. The upstream joint 32 is attached to the flow path unit 28. In one example, the upstream joint 32 is attached to the flow path unit 28 by a bolt 33 and a nut 34. One or more attachment holes 35 are open in the upstream joint 32. In one example, two attachment holes 35 are open in the upstream joint 32. The upstream joint 32 is attached to the flow path unit 28 by fastening the bolt 33 inserted into the attachment hole 35 with the nut 34.

One or more upstream coupling holes 36 are open in the upstream joint 32. In one example, four upstream coupling holes 36 are open in the upstream joint 32. The upstream coupling member 31 is inserted into the upstream coupling hole 36. Accordingly, the upstream joint 32 holds the upstream pipe 30. By holding the plurality of upstream pipes 30 by the upstream joint 32, the plurality of upstream pipes 30 can be handled as one. Thereby, the plurality of upstream pipes 30 can be attached to and detached from the flow path unit 28 all at once. Therefore, the upstream joint 32 facilitates attachment and detachment of the upstream coupling body 29 to and from the flow path unit 28.

The upstream coupling body 29 has a seal member 37. The seal member 37 is attached to the upstream coupling member 31. The seal member 37 seals the upstream coupling member 31 and the flow path unit 28. This reduces a possibility of liquid leaking between the upstream coupling member 31 and the flow path unit 28. The seal member 37 is located within the upstream joint 32 by inserting the upstream coupling member 31 into the upstream joint 32.

The coupling section 27 has a downstream coupling body 38. The downstream coupling body 38 is coupled to the flow path unit 28 and the printing section 21. The downstream coupling body 38 has one or more downstream pipes 39. In one example, the downstream coupling body 38 has four downstream pipes 39. The four downstream pipes 39 are each composed of a plurality of coupled tubes, for example. Like the upstream pipe 30, the downstream pipe 39 may be composed of an independent tube.

The downstream coupling body 38 may have a downstream joint 40. The downstream joint 40 is attached to the flow path unit 28. Like the upstream joint 32, the downstream joint 40 is attached to the flow path unit 28 by bolts 41. The downstream joint 40 holds the downstream pipe 39. The downstream joint 40 facilitates attachment and detachment of the downstream coupling body 38 to and from the flow path unit 28.

### Flow Path Unit

Next, the flow path unit 28 will be described.

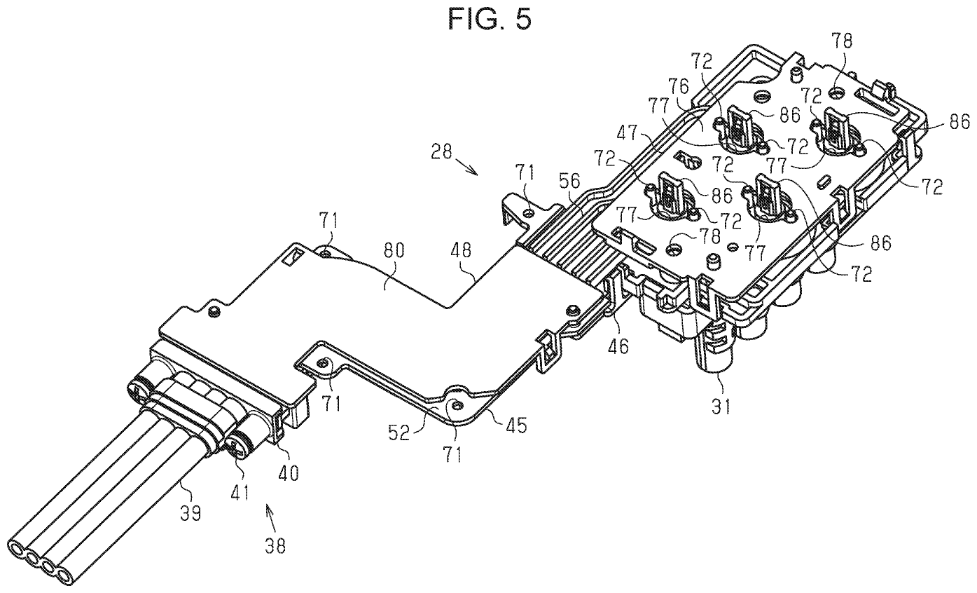

As illustrated in FIGS. 5, 6, and 7, the flow path unit 28 includes a flow path base material 45 and one or more flow path members. In one example, the flow path unit 28 includes a flow path base material 45, a first flow path member 46, a second flow path member 47, and a third flow path member 48. The flow path unit 28 is constituted by laser welding a flow path member to the flow path base material 45.

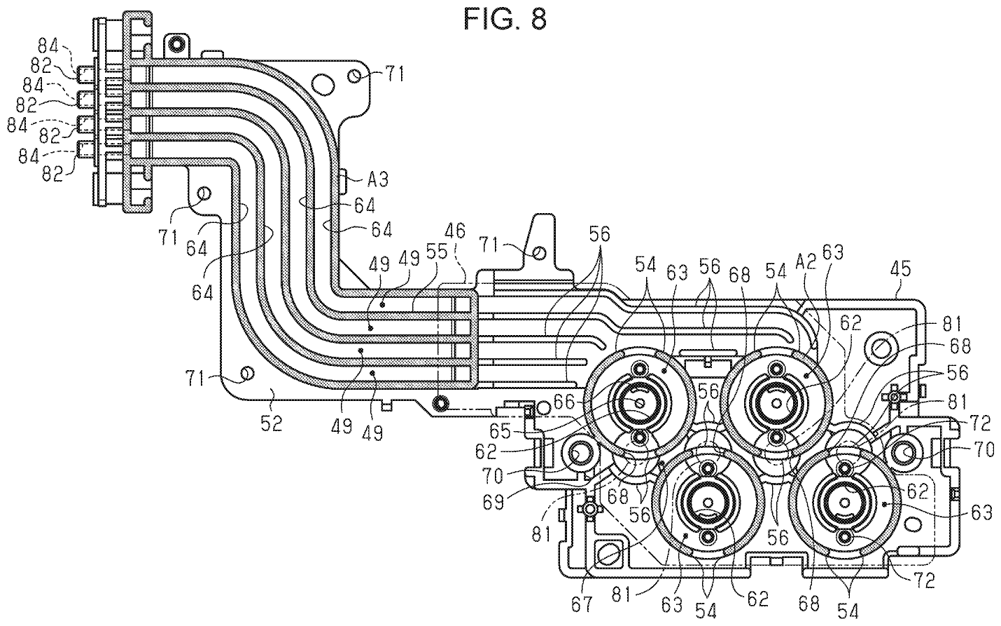

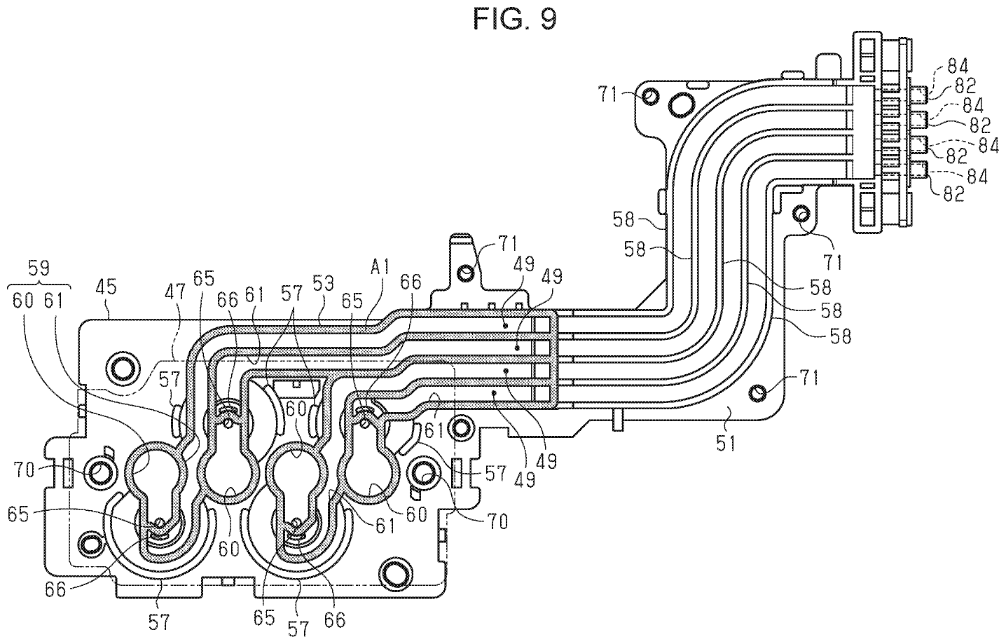

As illustrated in FIGS. 8 and 9, a flow path 49 is constituted by laser welding a flow path member to the flow path base material 45. That is, the flow path unit 28 constitutes the flow path 49. The flow path 49 is a space through which a liquid flows in the flow path unit 28. A liquid flows from the upstream coupling body 29 to the downstream coupling body 38 through the flow path 49.

The flow path base material 45 is absorbent to laser light. In one example, the flow path base material 45 is made of a black resin material. The flow path base material 45 is composed of a resin plate made of polyethylene, polypropylene, or the like.

As illustrated in FIGS. 5, 6, 7, 8, and 9, the flow path base material 45 has a first surface 51 and a second surface 52. The first surface 51 is a surface to which the first flow path member 46 is welded. In one example, the first surface 51 faces downward. The second surface 52 is a surface opposite to the first surface 51. The second surface 52 is a surface to which the second flow path member 47 is welded. In one example, the second surface 52 faces upward. The second surface 52 is also a surface to which the third flow path member 48 is welded.

A welding region is formed in the flow path base material 45. The welding region is a region of the flow path base material 45 welded to the flow path member. That is, the welding region indicates a region of the flow path base material 45 irradiated with laser light. A first welding region A1 is formed at the first surface 51. The first flow path member 46 is welded to the first welding region A1. A second welding region A2 is formed at the second surface 52. The second flow path member 47 is welded to the second welding region A2. A third welding region A3 is formed at the second surface 52. The third flow path member 48 is welded to the third welding region A3. The first welding region A1, the second welding region A2, and the third welding region A3 are respectively indicated by dot hatching in FIGS. 8 and 9.

The flow path base material 45 has a plurality of ribs. The flow path base material 45 has one or more welding ribs and one or more support ribs. In one example, the flow path base material 45 has a first welding rib 53, a second welding rib 54, a third welding rib 55, a first support rib 56, a second support rib 57, and a third support rib 58. The welding rib is a rib welded to the flow path member. The support rib is a rib that receives a load applied to the flow path base material 45 from the flow path member when the flow path member is welded to the flow path base material 45.

The first welding rib 53 is located on the first surface 51. The first welding rib 53 is welded to the first flow path member 46. Specifically, the top surface of the first welding rib 53 is welded to the first flow path member 46. That is, the first flow path member 46 is welded to the flow path base material 45 by irradiating the top surface of the first welding rib 53 with laser light. Therefore, the top surface of the first welding rib 53 is the first welding region A1.

The first welding rib 53 constitutes a relay flow path that is a portion of the flow path 49 by being welded to the first flow path member 46. Specifically, one or more first relay flow paths 59 are defined by welding the first flow path member 46 to the first welding region A1. In one example, four first relay flow paths 59 are defined by welding the first flow path member 46 to the first welding rib 53. The first relay flow path 59 includes, for example, a first upstream relay flow path 60 and a first downstream relay flow path 61.

The second welding rib 54 is located on the second surface 52. The second welding rib 54 is welded to the second flow path member 47. Specifically, the top surface of the second welding rib 54 is welded to the second flow path member 47. That is, the second flow path member 47 is welded to the flow path base material 45 by irradiating the top surface of the second welding rib 54 with laser light. Therefore, the top surface of the second welding rib 54 is the second welding region A2.

The second welding rib 54 constitutes a relay flow path that is a portion of the flow path 49 by being welded to the second flow path member 47. Specifically, one or more second relay flow paths 62 are defined by welding the second flow path member 47 to the second welding region A2. In one example, four second relay flow paths 62 are defined by welding the second flow path member 47 to the second welding rib 54. The second relay flow path 62 communicates with the first relay flow path 59. The second relay flow path 62 communicates with the first upstream relay flow path 60. The second relay flow path 62 communicates with the first downstream relay flow path 61.

The second welding rib 54 may constitute one or more accommodation chambers 63 by being welded to the second flow path member 47. That is, one or more accommodation chambers 63 may be defined by welding the second flow path member 47 to the second welding region A2. The accommodation chamber 63 is a space in which a displacement section 86, which will be described later, is accommodated. The accommodation chamber 63 is separated from the second relay flow path 62 by the displacement section 86. In one example, four accommodation chambers 63 are defined. When viewed from the second surface 52, the four accommodation chambers 63 are alternately arranged on the second surface 52. The four accommodation chambers 63 may be arranged in a row on the second surface 52.

The second welding region A2 is located inside an outer shape of the first flow path member 46. Accordingly, when the second flow path member 47 is welded to the second welding region A2, the flow path base material 45 is easily stabilized. In the flow path unit 28, the second flow path member 47 may be welded to the flow path base material 45 after the first flow path member 46 is welded. In this case, the second flow path member 47 is welded to the flow path base material 45 in a state where the first flow path member 46 is installed. Therefore, the larger the area in which the first flow path member 46 is installed, the easier the flow path base material 45 is stabilized.

The third welding rib 55 is located on the second surface 52. The third welding rib 55 is welded to the third flow path member 48. Specifically, the top surface of the third welding rib 55 is welded to the third flow path member 48. That is, the third flow path member 48 is welded to the flow path base material 45 by irradiating the top surface of the third welding rib 55 with laser light. Therefore, the top surface of the third welding rib 55 is the third welding region A3.

The third welding rib 55 constitutes a relay flow path that is a portion of the flow path 49 by being welded to the third flow path member 48. Specifically, one or more third relay flow paths 64 are defined by welding the third flow path member 48 to the third welding region A3. In one example, four third relay flow paths 64 are defined by welding the third flow path member 48 to the third welding rib 55. The third relay flow path 64 communicates with the second relay flow path 62.

The first support rib 56 is located on the second surface 52. The first support rib 56 receives a load when the first flow path member 46 is welded to the first welding rib 53. When the first flow path member 46 is welded to the first surface 51, the second surface 52 is installed. At this time, since the first flow path member 46 is laser-welded to the flow path base material 45 while being pressed against the first surface 51, a load is applied to the first support rib 56. The first support rib 56 may be located to overlap the first welding rib 53 when viewed from the second surface 52. In this case, the first support rib 56 can effectively receive the load of the first flow path member 46 pressed against the first welding rib 53.

The second support rib 57 is located on the first surface 51. The second support rib 57 receives a load when the second flow path member 47 is welded to the second welding rib 54. When the second flow path member 47 is welded to the second surface 52, the first surface 51 is installed. At this time, since the second flow path member 47 is laser-welded to the flow path base material 45 while being pressed against the second surface 52, a load is applied to the second support rib 57. The second support rib 57 may be located to overlap the second welding rib 54 when viewed from the first surface 51. In this case, the second support rib 57 can effectively receive the load of the second flow path member 47 pressed against the second welding rib 54.

The third support rib 58 is located on the first surface 51. The third support rib 58 receives a load when the third flow path member 48 is welded to the third welding rib 55. When the third flow path member 48 is welded to the second surface 52, the first surface 51 is installed. At this time, since the third flow path member 48 is laser-welded to the flow path base material 45 while being pressed against the second surface 52, a load is applied to the third support rib 58. The third support rib 58 may be located to overlap the third welding rib 55 when viewed from the first surface 51. In this case, the third support rib 58 can effectively receive the load of the third flow path member 48 pressed against the third welding rib 55.

The width of the support rib is smaller than the width of the welding rib. Therefore, the rigidity of the support rib is smaller than the rigidity of the welding rib. Therefore, when the flow path member is pressed against the welding rib, the support rib is likely to bend. By bending the support rib, the top surface of the welding rib becomes easier to follow the flow path member. That is, the top surface of the welding rib can easily come into uniform contact with the flow path member. When the support rib does not bend, it is difficult for the top surface of the welding rib to uniformly contact the flow path member due to the tolerance of the welding rib.

One or more relay ports are open in the flow path base material 45. In one example, one or more first relay ports 65 and one or more second relay ports 66 are open in the flow path base material 45. The relay port penetrates the flow path base material 45. The relay port constitutes a portion of the flow path 49. The relay port allows the first relay flow path 59 and the second relay flow path 62 to communicate with each other. Specifically, the first relay port 65 allows the first upstream relay flow path 60 and the second relay flow path 62 to communicate with each other. The second relay port 66 allows the first downstream relay flow path 61 and the second relay flow path 62 to communicate with each other.

A discharge path 67 may be formed in the flow path base material 45. The discharge path 67 is a path through which the liquid leaking from the accommodation chamber 63 flows. The discharge path 67 is defined by the second welding rib 54 and the first support rib 56. The discharge path 67 communicates with a leakage port 68. The leakage port 68 is an opening that communicates with the accommodation chamber 63. The leakage port 68 opens to the second welding rib 54 that partitions the accommodation chamber 63. When the displacement section 86 cannot correctly partition the accommodation chamber 63 and the second relay flow path 62, there is a possibility that the liquid may flow from the second relay flow path 62 to the accommodation chamber 63. In this case, the liquid flows out from the accommodation chamber 63 to the discharge path 67 through the leakage port 68.

The discharge port 69 may be open in the flow path base material 45. The discharge port 69 penetrates the flow path base material 45. The discharge port 69 communicates with the discharge path 67. Therefore, the liquid flowing in the discharge path 67 is discharged through the discharge port 69. For example, the flow path unit 28 may include a liquid sensor that detects a liquid dripping from the discharge port 69. In this case, liquid leakage in the flow path unit 28 is detected by the liquid sensor detecting the liquid.

One or more bolt holes 70 are open in the flow path base material 45. In one example, two bolt holes 70 are open in the flow path base material 45. The bolt hole 70 overlaps the attachment hole 35. The bolt 33 is inserted into the bolt hole 70.

An inspection mark 71 may be attached to the flow path base material 45. In one example, the inspection mark 71 is a hole. The inspection mark 71 is a mark for inspecting whether or not the flow path member is correctly welded to the flow path base material 45. After the flow path member is welded to the flow path base material 45, the flow path unit 28 is inspected by analyzing a captured image captured by the flow path unit 28. Specifically, the flow path unit 28 is inspected by detecting the position, shape, and the like of the welding region based on the inspection mark 71 in the captured image. Therefore, the inspection mark 71 is located at a position that does not overlap the flow path member on the flow path base material 45 when viewed from the first surface 51. The inspection mark 71 is not limited to the hole, and may be an identifier such as a mark or a code.

The flow path base material 45 may have one or more guide pins 72 for each accommodation chamber 63. In one example, the flow path base material 45 has two guide pins 72 for each accommodation chamber 63. The guide pin 72 is located on the second surface 52. The guide pin 72 is located in the accommodation chamber 63. The guide pin 72 guides the displacement section 86. When guided by two guide pins 72, the displacement section 86 is more stable than when guided by one guide pin 72.

The flow path member is transparent to laser light. In one example, the flow path member is made of a transparent resin material. The flow path member is made of a plate material. The flow path member is composed of, for example, a resin plate made of polyethylene, polypropylene, or the like. The flow path member has a welding surface and an opposite surface. The welding surface is a surface welded to the welding region. The opposite surface is a surface opposite to the welding surface in the flow path member.

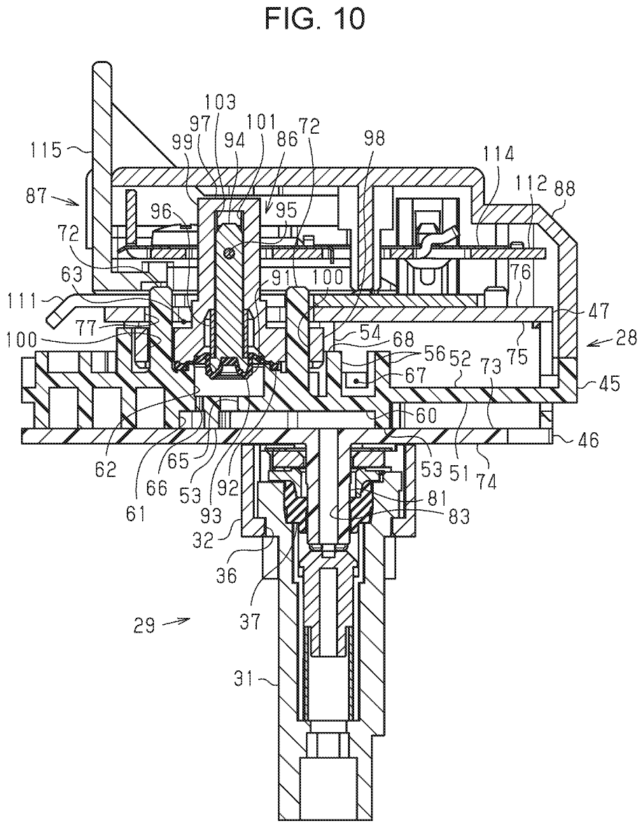

As illustrated in FIG. 10, the first flow path member 46 has a first welding surface 73 and a first opposite surface 74. The first welding surface 73 is a surface welded to the first welding region A1. Therefore, the first welding surface 73 faces the first surface 51. In one example, the first opposite surface 74 faces downward.

The second flow path member 47 has a second welding surface 75 and a second opposite surface 76. The second welding surface 75 is a surface welded to the second welding region A2. Therefore, the second welding surface 75 faces the second surface 52. In one example, the second opposite surface 76 faces upward.

One or more insertion ports 77 may be open in the second flow path member 47. In one example, four insertion ports 77 are open in the second flow path member 47. The insertion port 77 is an opening into which the displacement section 86 is inserted. The insertion port 77 communicates with the accommodation chamber 63. Therefore, the accommodation chamber 63 is open to the outside of the flow path unit 28 through the insertion port 77. Therefore, a user can operate the displacement section 86 through the insertion port 77. The guide pin 72 is also inserted into the insertion port 77.

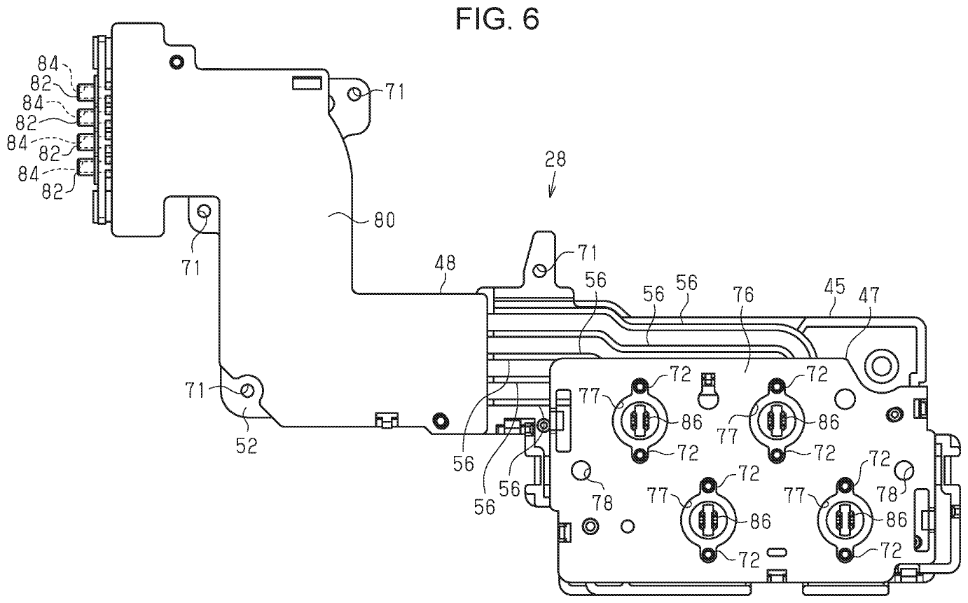

As illustrated in FIGS. 5 and 6, one or more fastening holes 78 may be open in the second flow path member 47. In one example, two fastening holes 78 are open in the second flow path member 47. The bolt 33 is inserted into the fastening hole 78.

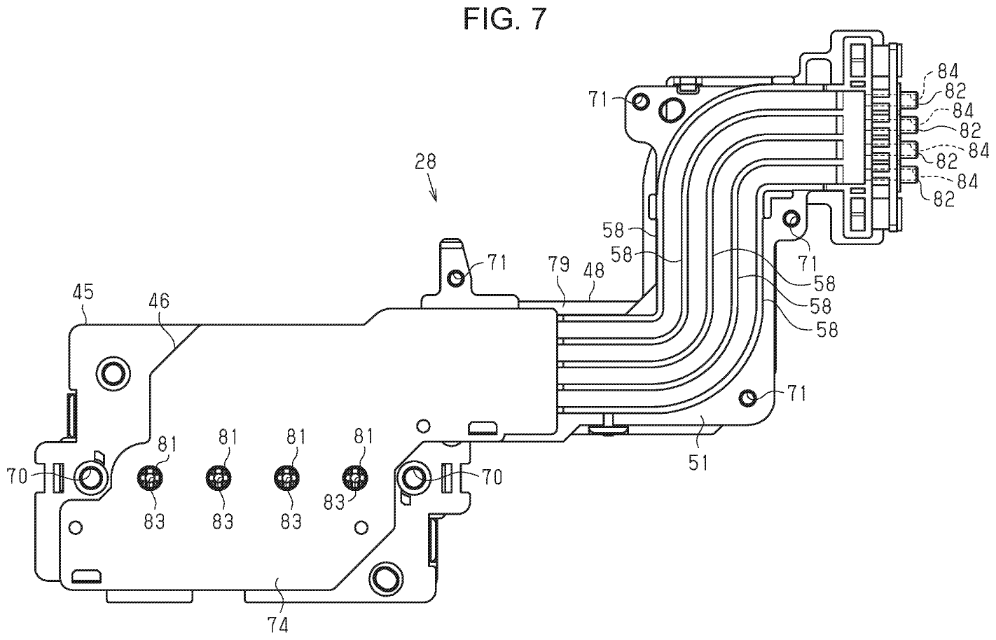

As illustrated in FIGS. 6 and 7, the third flow path member 48 has a third welding surface 79 and a third opposite surface 80. The third welding surface 79 is a surface welded to the third welding region A3. Therefore, the third welding surface 79 faces the second surface 52. In one example, the third opposite surface 80 faces upward.

The flow path unit 28 includes a plurality of coupling pipes. The flow path unit 28 includes one or more first coupling pipes 81 and one or more second coupling pipes 82. In one example, the flow path unit 28 includes four first coupling pipes 81 and four second coupling pipes 82. The coupling pipes include a pipe for introducing a liquid into the flow path unit 28 and a pipe for leading out the liquid from the flow path unit 28.

Coupling flow path opens in each of the plurality of coupling pipes. The coupling flow path constitutes a portion of the flow path 49. The coupling flow path communicates with the relay flow path. A first coupling flow path 83 opens in the first coupling pipe 81. The first coupling flow path 83 communicates with the first relay flow path 59. Specifically, the first coupling flow path 83 communicates with the first upstream relay flow path 60. A second coupling flow path 84 opens in the second coupling pipe 82. In one example, the second coupling flow path 84 communicates with the third relay flow path 64.

As illustrated in FIGS. 7 and 10, the first coupling pipe 81 is located in the first flow path member 46. That is, the first flow path member 46 has the first coupling pipe 81. The first coupling pipe 81 extends from the first opposite surface 74. The first coupling pipe 81 extends perpendicularly to the first opposite surface 74. Therefore, the first coupling pipe 81 is located in the flow path base material 45 to extend from the first surface 51. In one example, the first coupling pipe 81 extends downward.

The first coupling pipe 81 is coupled to the upstream coupling body 29. The first coupling pipe 81 is inserted into the upstream coupling member 31. The first coupling pipe 81 contacts the seal member 37 inside the upstream coupling member 31. Accordingly, the first coupling pipe 81 is sealed against the upstream coupling member 31. By inserting the first coupling pipe 81 into the upstream coupling member 31, the liquid can be introduced from the upstream pipe 30 into the first coupling pipe 81.

As illustrated in FIG. 8, when viewed in the direction in which the first coupling pipe 81 extends, for example, when viewed from the second surface 52, the first coupling pipe 81 is located at a position that does not overlap the second welding region A2. Accordingly, when the second flow path member 47 is welded to the flow path base material 45, the flow path base material 45 is easily stabilized. When the first coupling pipe 81 is located at a position overlapping the second welding region A2, there is a possibility that the second flow path member 47 is welded to the second welding region A2 in a state where the tip of the first coupling pipe 81 is installed. Therefore, when the first coupling pipe 81 is located at a position overlapping the second welding region A2, the posture during welding may be difficult to stabilize.

As illustrated in FIGS. 6 and 7, the second coupling pipe 82 is located in the flow path base material 45. That is, the flow path base material 45 has the second coupling pipe 82. The second coupling pipe 82 is located in the flow path base material 45 to extend in a different direction from the first coupling pipe 81. The second coupling pipe 82 extends horizontally, for example. The second coupling pipe 82 may extend upward or extend downward.

The second coupling pipe 82 is coupled to the downstream coupling body 38. Accordingly, the liquid can be led out from the second coupling pipe 82 to the downstream pipe 39. The second coupling pipe 82 may be located in the flow path member. The second coupling pipe 82 may be located in the second flow path member 47 or located in the third flow path member 48, for example.

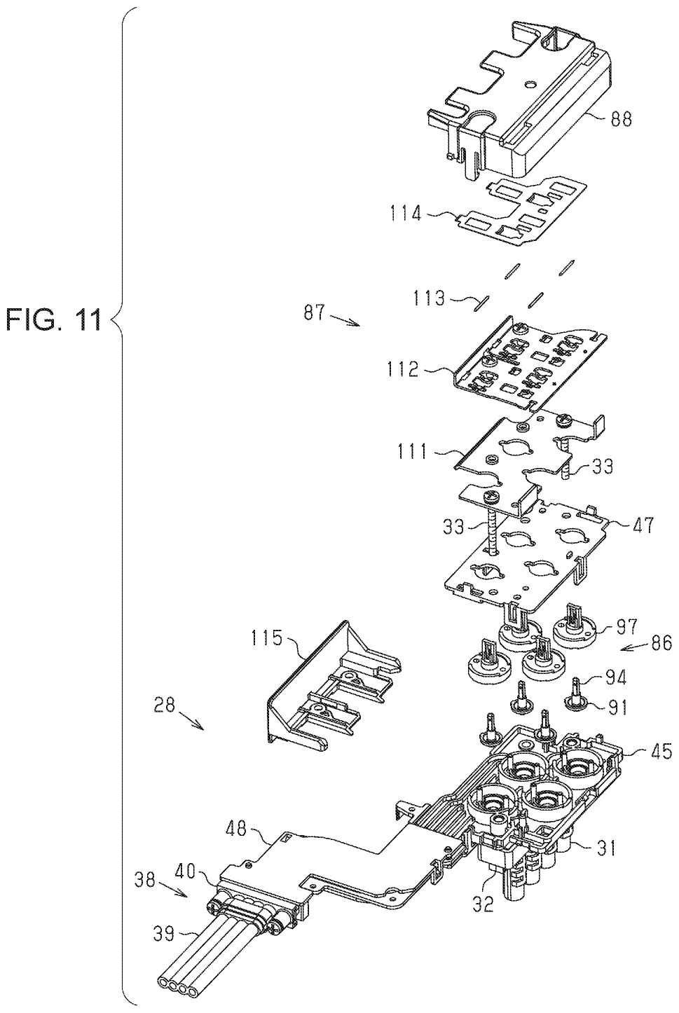

As illustrated in FIG. 11, the flow path unit 28 may include one or more displacement sections 86. In one example, the flow path unit 28 includes four displacement sections 86. The displacement section 86 is configured to be displaceable with respect to the flow path base material 45. The flow path unit 28 may include an operating mechanism 87. The operating mechanism 87 is a mechanism for operating the displacement section 86. The flow path unit 28 may include a protective cover 88. The protective cover 88 is a cover that protects the displacement section 86 and the operating mechanism 87.

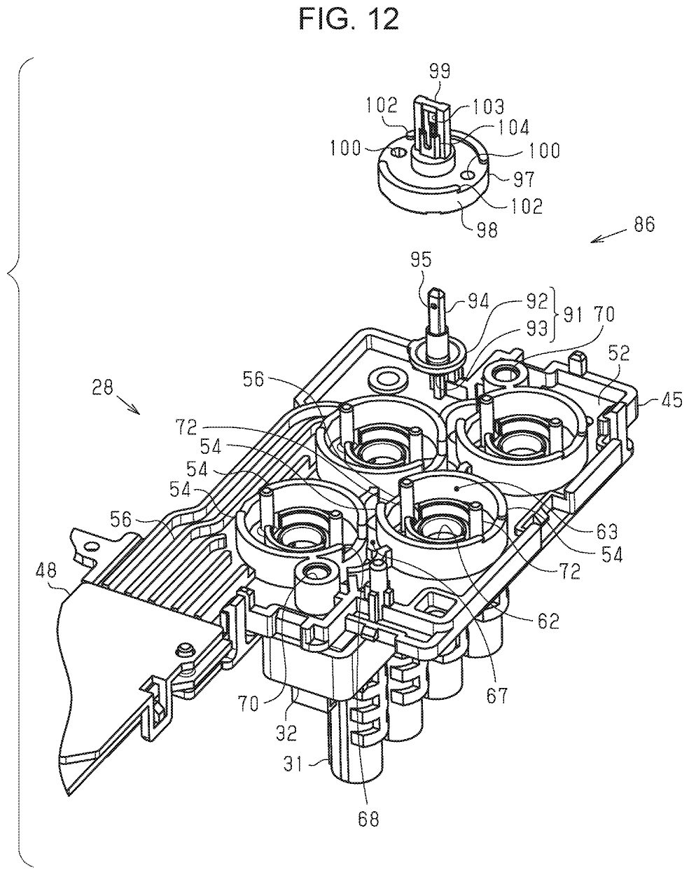

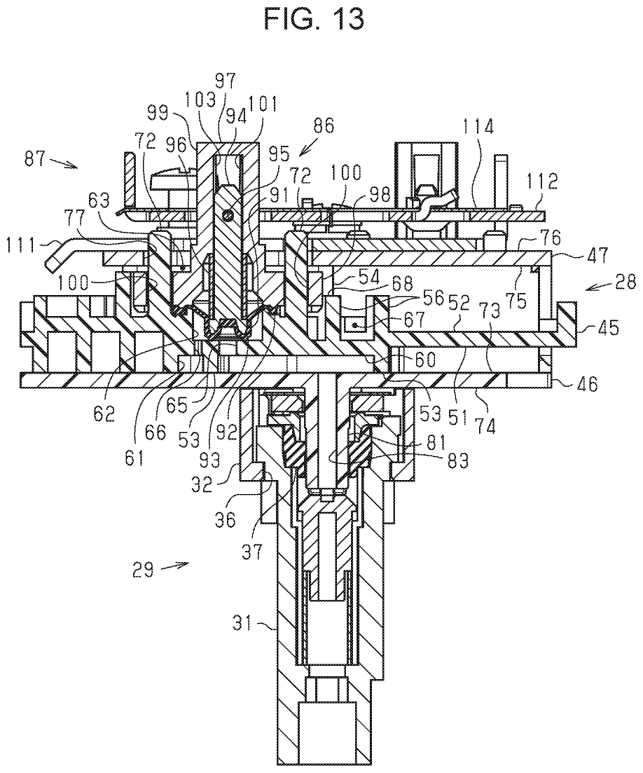

As illustrated in FIGS. 10, 12, and 13, the displacement section 86 has an elastic member 91. The elastic member 91 is a member having elasticity. The displacement section 86 is displaced by elastic deformation of the elastic member 91. The elastic member 91 is made of a rubber film, for example.

The elastic member 91 is pressed from the second flow path member 47 toward the flow path base material 45. The elastic member 91 is pressed against the flow path base material 45 by the second flow path member 47. Specifically, a peripheral edge portion of the elastic member 91 is pressed against the flow path base material 45 by the second flow path member 47. Accordingly, the elastic member 91 partitions the accommodation chamber 63 and the second relay flow path 62. That is, the elastic member 91 defines the second relay flow path 62. Therefore, the second relay flow path 62 extends between the flow path base material 45 and the elastic member 91. The elastic member 91 may be directly or indirectly pressed against the flow path base material 45 by the second flow path member 47. In one example, the elastic member 91 is pressed against the flow path base material 45 via a holder 97, which will be described later.

The elastic member 91 is located between the flow path base material 45 and the second flow path member 47. The elastic member 91 is compressed by the second flow path member 47 being pressed against the flow path base material 45 when the second flow path member 47 is welded to the flow path base material 45. By compressing the elastic member 91, looseness between the flow path base material 45 and the second flow path member 47 is absorbed. This makes it easier for the second flow path member 47 to follow the top surface of the second welding rib 54. That is, the second flow path member 47 can easily come into uniform contact with the top surface of the second welding rib 54. When the elastic member 91 is not located between the flow path base material 45 and the second flow path member 47, it is difficult for the second flow path member 47 to uniformly contact the top surface of the second welding rib 54 due to the tolerances of the flow path base material 45 and the second flow path member 47.

The elastic member 91 has an attachment portion 92 and a displacement portion 93. The attachment portion 92 is a portion attached to the flow path base material 45. In one example, the attachment portion 92 is a peripheral edge portion of the elastic member 91. The attachment portion 92 is pressed from the second flow path member 47 toward the flow path base material 45. By compressing the attachment portion 92, looseness between the flow path base material 45 and the second flow path member 47 is absorbed. In one example, the attachment portion 92 is sandwiched between the holder 97 and the flow path base material 45. The displacement portion 93 is a portion displaced with respect to the flow path base material 45. In one example, the displacement portion 93 is a central portion of the elastic member 91. Due to the displacement of the displacement portion 93, the volume of the second relay flow path 62 increases or decreases.

The displacement section 86 has a displacement shaft 94. The displacement shaft 94 extends perpendicular to the second surface 52. The displacement shaft 94 extends from the elastic member 91. The displacement shaft 94 is attached to the elastic member 91. Specifically, a base end portion of the displacement shaft 94 is attached to the displacement portion 93. Therefore, the displacement shaft 94 is displaced together with the elastic member 91. A pin hole 95 may be open at the tip portion of the displacement shaft 94. The pin hole 95 is a hole into which an operation pin 113, which will be described later, is inserted.

The displacement shaft 94 is inserted into the insertion port 77. Therefore, the displacement shaft 94 can be exposed to the outside of the flow path unit 28 through the insertion port 77. A user can displace the elastic member 91 by operating the displacement shaft 94. For example, by displacing the elastic member 91, the user can cause the displacement section 86 to function as a diaphragm pump. Further, the user can ascertain the pressure, the amount of liquid, and the like inside the second relay flow path 62 by monitoring the position of the displacement shaft 94.

The displacement section 86 may have a pressing member 96. The pressing member 96 is, for example, a spring. The pressing member 96 is attached to the displacement shaft 94. The pressing member 96 presses the displacement shaft 94 with respect to the holder 97 toward the flow path base material 45. That is, the pressing member 96 presses the displacement portion 93 against the flow path base material 45.

The pressing member 96 may bring the displacement portion 93 into contact with the flow path base material 45 by pressing the displacement portion 93. The pressing member 96 may close the second relay flow path 62 by bringing the displacement portion 93 into contact with the second surface 52. In one example, the pressing member 96 closes the first relay port 65 by pressing the displacement portion 93. Accordingly, the second relay flow path 62 is closed. When the displacement portion 93 is separated from the flow path base material 45 by operating the displacement shaft 94, the second relay flow path 62 is opened. In this way, the displacement section 86 may function as a valve that opens and closes the second relay flow path 62. Normally, the second relay flow path 62 is open. Since the displacement section 86 closes the second relay flow path 62, the upstream coupling body 29 can be removed from the flow path unit 28. Therefore, the maintainability of the liquid ejecting apparatus 11 is improved.

The displacement section 86 has the holder 97. The holder 97 is configured to hold the elastic member 91, the displacement shaft 94, and the pressing member 96. The holder 97 has a pressing portion 98 and an accommodation portion 99. The pressing portion 98 is a portion that presses the attachment portion 92 against the flow path base material 45. The pressing portion 98 fits in the accommodation chamber 63. The pressing portion 98 is sandwiched between the flow path base material 45 and the second flow path member 47. Accordingly, the holder 97 presses the elastic member 91 against the flow path base material 45. The accommodation portion 99 is a portion that accommodates the displacement shaft 94. The accommodation portion 99 is inserted into the insertion port 77. The pressing member 96 is attached to the accommodation portion 99.

One or more guide holes 100 are open in the holder 97. In one example, two guide holes 100 are open in the holder 97. The guide hole 100 penetrates the pressing portion 98. The guide pin 72 is inserted into the guide hole 100. Accordingly, the holder 97 is held against the flow path base material 45.

A shaft hole 101 is open in the holder 97. The shaft hole 101 opens to the accommodation portion 99. The tip portion of the displacement shaft 94 is inserted into the shaft hole 101. The displacement shaft 94 is displaced along the shaft hole 101.

The holder 97 may have a contact rib 102. The contact rib 102 is a rib that contacts the second flow path member 47. The contact rib 102 is located at the pressing portion 98. When the contact rib 102 contacts the second flow path member 47, the pressing portion 98 is pressed against the flow path base material 45. The contact rib 102 may be welded to the second flow path member 47. In this case, the holder 97 is made of a resin material absorbent to laser light. When the holder 97 is welded to the second flow path member 47, the position of the holder 97 is stabilized.

An exposure opening 103 is open in the holder 97. The exposure opening 103 opens to the accommodation portion 99. The exposure opening 103 penetrates the accommodation portion 99. The exposure opening 103 communicates with the shaft hole 101. The exposure opening 103 exposes the displacement shaft 94 inserted into the shaft hole 101. Specifically, the exposure opening 103 exposes the pin hole 95. This allows the displacement shaft 94 to be operated from outside the holder 97.

The holder 97 may have a pin guide 104. The pin guide 104 is located in the accommodation portion 99. The pin guide 104 is configured to guide the operation pin 113. Specifically, the pin guide 104 guides the operation pin 113 to be inserted into the pin hole 95. By operating the operation pin 113 in a state of being received by the pin guide 104, the operation pin 113 is easily inserted into the pin hole 95.

The pin guide 104 may guide the displacement shaft 94 located in the shaft hole 101. For example, the pin guide 104 guides the displacement shaft 94 by contacting the tip portion of the displacement shaft 94 exposed from the exposure opening 103. The pin guide 104 guides the displacement shaft 94 to restrict the displacement shaft 94 from protruding from the exposure opening 103. Accordingly, the possibility that the displacement shaft 94 will be inclined in the shaft hole 101 is reduced.

In attaching the displacement section 86 to the flow path base material 45, first, the elastic member 91, the displacement shaft 94, and the pressing member 96 are located in the accommodation chamber 63. Next, the holder 97 is located in the accommodation chamber 63 such that the holder 97 covers the elastic member 91, the displacement shaft 94, and the pressing member 96. Specifically, the holder 97 is located in the accommodation chamber 63 while the guide pin 72 and the displacement shaft 94 are inserted into the guide hole 100 and the shaft hole 101, respectively.

The holder 97 is configured such that the guide pin 72 is inserted into the guide hole 100 before the displacement shaft 94 is inserted into the shaft hole 101. That is, the holder 97 is configured such that the displacement shaft 94 is not located in the shaft hole 101 in a state where the tip of the guide pin 72 contacts the lower end surface of the accommodation portion 99. Accordingly, the displacement shaft 94 is inserted into the shaft hole 101 in a state where the holder 97 is guided by the guide pin 72. Therefore, the displacement shaft 94 is easily inserted into the shaft hole 101.

As illustrated in FIG. 11, the operating mechanism 87 has a protective plate 111, an operation plate 112, an operation pin 113, a pressing plate 114, and a slider 115. The operating mechanism 87 is configured to operate the plurality of displacement sections 86 all at once. That is, the operating mechanism 87 operates the four displacement shafts 94 such that the four elastic members 91 open the plurality of second relay flow paths 62, respectively. Accordingly, the number of times of operation can be reduced as compared with the case where the displacement shafts 94 are operated one by one.

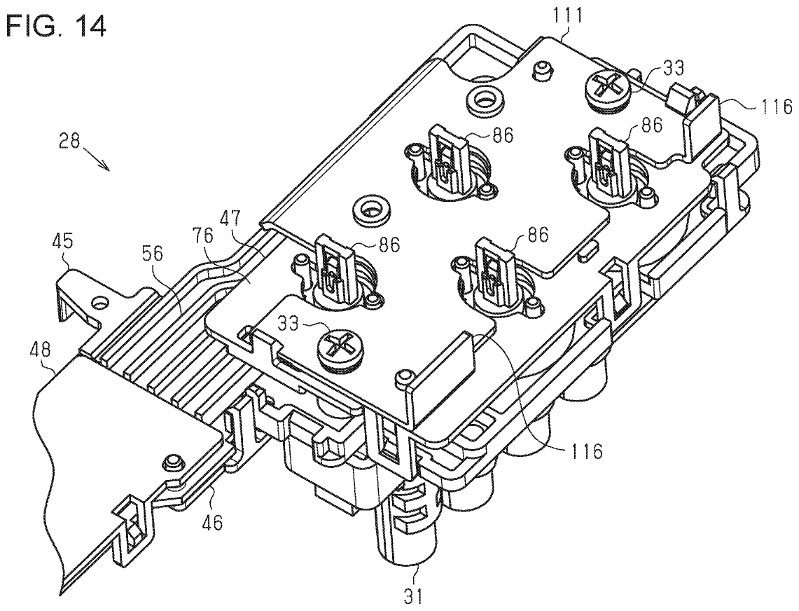

As illustrated in FIG. 14, the protective plate 111 faces the second flow path member 47. Specifically, the protective plate 111 faces the second opposite surface 76. The protective plate 111 is a plate that protects the second flow path member 47. The protective plate 111 covers the second opposite surface 76 to expose the displacement section 86. The protective plate 111 is attached to the flow path unit 28 by inserting the bolt 33.

The protective plate 111 has a guide portion 116. The guide portion 116 extends in a direction perpendicular to the second opposite surface 76. The guide portion 116 is a portion that guides the movement of the operation plate 112.

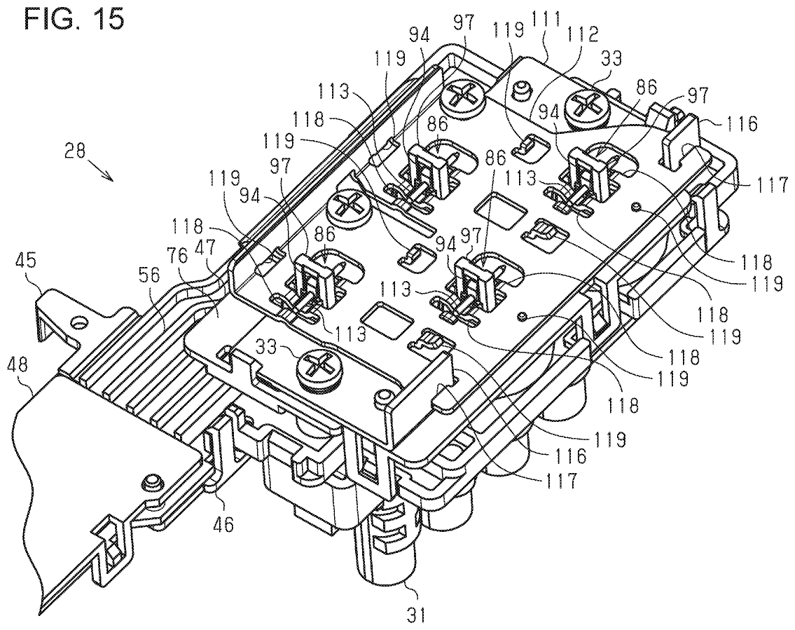

As illustrated in FIG. 15, the operation plate 112 faces the protective plate 111. The operation plate 112 is a plate that operates the displacement shaft 94. The operation plate 112 is attached to the protective plate 111. The operation plate 112 is movably attached to the protective plate 111. The operation plate 112 is movable in a direction in which the guide portion 116 extends.

A guide slit 117 is formed in the operation plate 112. The guide portion 116 is inserted into the guide slit 117. Accordingly, the operation plate 112 can move along the guide portion 116.

The operation plate 112 has a pin receiver 118. The pin receiver 118 is a portion that receives the operation pin 113 inserted into the displacement shaft 94. The operation plate 112 is attached to the protective plate 111, and then the operation pin 113 is inserted into the displacement shaft 94, whereby the pin receiver 118 receives the operation pin 113. When the pin receiver 118 receives the operation pin 113, the displacement shaft 94 is displaced together with the operation plate 112. That is, by displacing the operation plate 112, the displacement shaft 94 can be displaced.

The operation plate 112 has a holding portion 119. The holding portion 119 is a portion that holds the pressing plate 114. The holding portion 119 is a boss, a hole, a protrusion, or the like. The holding portion 119 attaches the pressing plate 114 to the holding portion 119.

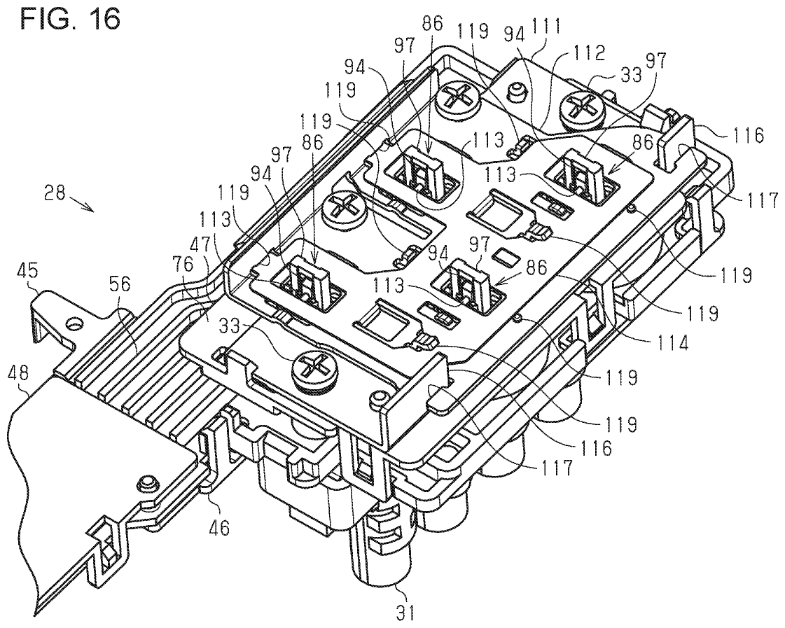

As illustrated in FIG. 16, the pressing plate 114 faces the operation plate 112. The pressing plate 114 is a plate that presses the operation pin 113. The pressing plate 114 presses the operation pin 113 by being attached to the operation plate 112. That is, the operation pin 113 is sandwiched between the operation plate 112 and the pressing plate 114.

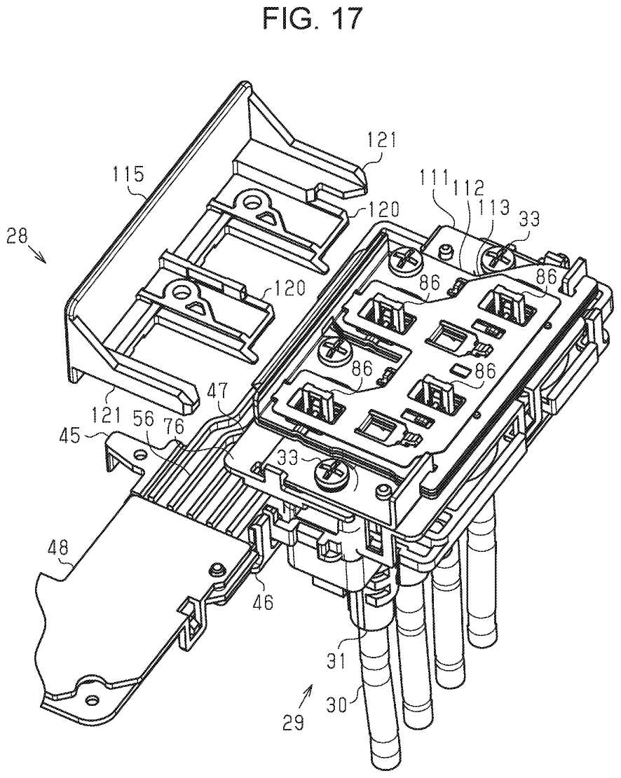

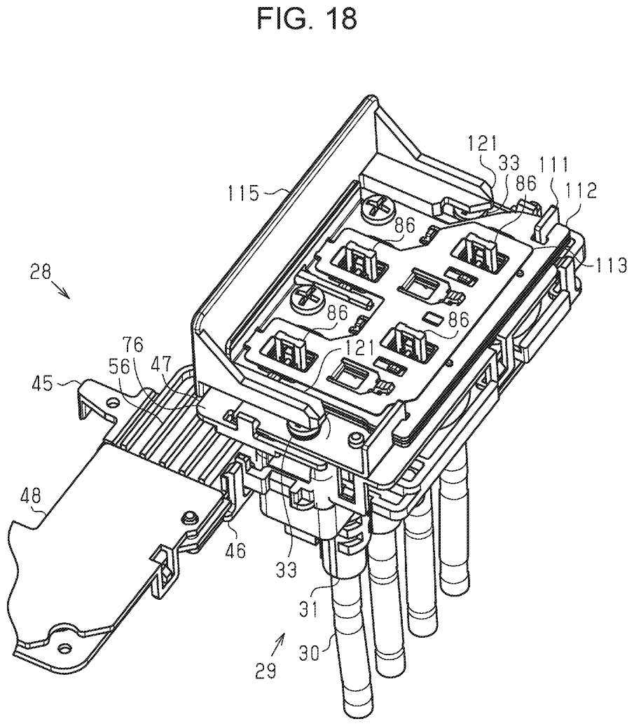

As illustrated in FIGS. 17 and 18, the slider 115 is a member that displaces the operation plate 112. The slider 115 has an insertion portion 120. The insertion portion 120 is inserted between the protective plate 111 and the operation plate 112. By inserting the insertion portion 120, the operation plate 112 is displaced to be separated from the protective plate 111. Accordingly, the displacement shaft 94 is displaced together with the operation plate 112. As a result, the displacement portion 93 is separated from the flow path base material 45. Therefore, when the slider 115 is inserted, the displacement section 86 opens the relay flow path. When the slider 115 is pulled out, the displacement section 86 closes the relay flow path.

Since four displacement sections 86 are alternately arranged, the slider 115 displaces the four displacement sections 86 two by two in the process of being inserted between the protective plate 111 and the operation plate 112. When the four displacement sections 86 are arranged in a horizontal row with respect to the direction in which the slider 115 is inserted, the slider 115 displaces the four displacement sections 86 all at once. In this case, the resistance applied to the slider 115 is large. In this regard, by arranging the four displacement sections 86 two by two in the direction in which the slider 115 is inserted, the resistance applied to the slider 115 is reduced. Therefore, the slider 115 can be easily inserted and removed.

The slider 115 may have a restriction portion 121. The restriction portion 121 is a portion that restricts access to the bolt 33. In a state where the slider 115 is inserted between the protective plate 111 and the operation plate 112, the restriction portion 121 is located to cover the bolt 33. Therefore, in a state where the slider 115 is inserted between the protective plate 111 and the operation plate 112, the user cannot access the bolt 33.

When the user maintains the liquid ejecting apparatus 11, the user removes the upstream coupling body 29 from the flow path unit 28 by removing the bolt 33. At this time, when the upstream coupling body 29 is removed in a state where the relay flow path is open, there is a possibility that the liquid may leak from the flow path unit 28. Therefore, when maintaining the flow path unit 28, it is preferable that the relay flow path is closed first. Since the restriction portion 121 restricts access to the bolt 33, the user can remove the bolt 33 after pulling out the slider 115. Since the relay flow path is closed by pulling out the slider 115, the possibility of the liquid leaking from the flow path unit 28 is reduced when the upstream coupling body 29 is removed from the flow path unit 28.

### Method of Manufacturing Flow Path Unit

Next, a method of manufacturing the flow path unit 28 will be described.

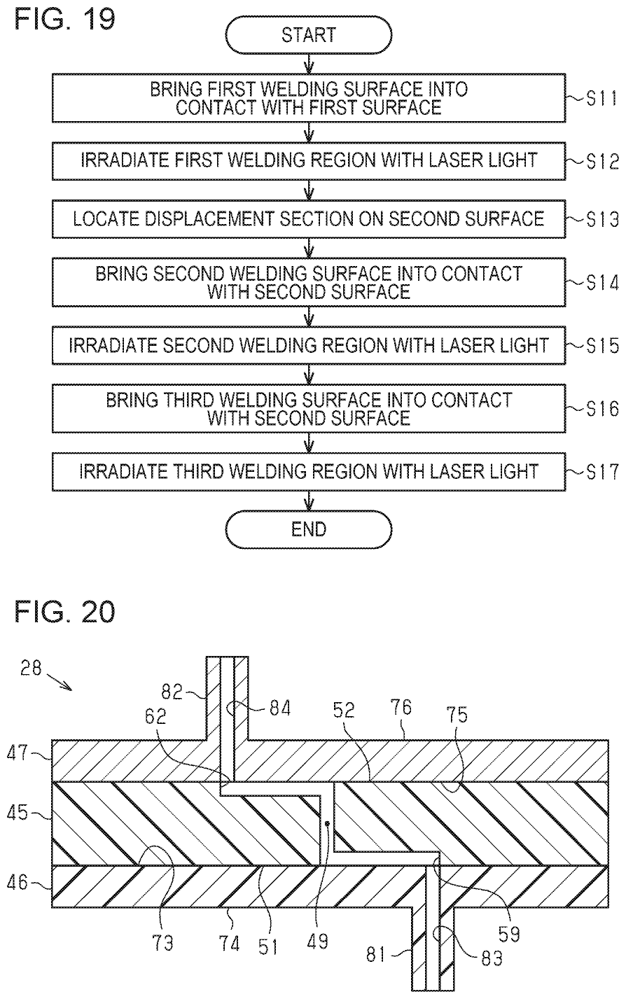

As illustrated in FIG. 19, in step S11, the first welding surface 73 is brought into contact with the first surface 51.

In step S12, the first welding region A1 is irradiated with laser light. That is, a region of the first surface 51 in contact with the first welding surface 73 is irradiated with laser light. Accordingly, the first flow path member 46 is welded to the flow path base material 45. At this time, the first relay flow path 59 is defined.

In step S13, the displacement section 86 is located on the second surface 52. Specifically, the displacement section 86 is located on the second surface 52 at a location where the accommodation chamber 63 is defined.

In step S14, the second welding surface 75 is brought into contact with the second surface 52. At this time, the second welding surface 75 is brought into contact with the second surface 52 in a state where the elastic member 91 is pressed from the second flow path member 47 toward the flow path base material 45.

In step S15, the second welding region A2 is irradiated with laser light. That is, a region of the second surface 52 in contact with the second welding surface 75 is irradiated with laser light. Accordingly, the second flow path member 47 is welded to the flow path base material 45. In one example, the second welding region A2 located at a position that does not overlap the first coupling pipe 81 when viewed in the direction in which the first coupling pipe 81 extends is irradiated with laser light. This is because the second welding rib 54 is located at a position that does not overlap the first coupling pipe 81.

In step S15, the second relay flow path 62 is defined by welding the second flow path member 47 to the flow path base material 45. At this time, the accommodation chamber 63 is defined. As a result, the displacement section 86 is accommodated in the accommodation chamber 63. In step S15, the holder 97 may be irradiated with laser light. Accordingly, the holder 97 is welded to the second flow path member 47.

In step S16, the third welding surface 79 is brought into contact with the second surface 52.

In step S17, the third welding region A3 is irradiated with laser light. That is, a region of the second surface 52 in contact with the third welding surface 79 is irradiated with laser light. Accordingly, the third flow path member 48 is welded to the flow path base material 45. Through the above steps, the flow path unit 28 is manufactured.

### Operation and Effect

Next, the operation and effect of the above embodiment will be described.

(1) The first flow path member 46 has the first welding surface 73, the first opposite surface 74, and the first coupling pipe 81. The first coupling flow path 83, which is a portion of the flow path 49, opens in the first coupling pipe 81. The first coupling flow path 83 communicates with the first relay flow path 59.

Since the first coupling pipe 81 extends from the first opposite surface 74, the first coupling pipe 81 is located to extend from the first surface 51 defining the first relay flow path 59 in the flow path base material 45. When the first coupling pipe 81 is located to extend from the first surface 51 defining the first relay flow path 59, the flow path 49 becomes shorter than when the first coupling pipe 81 is located to extend from the second surface 52. Therefore, according to the above configuration, the pressure loss in the flow path 49 is reduced. When the first coupling pipe 81 is located to extend from the second surface 52, the first relay flow path 59 defined by the first surface 51 will be coupled to the first coupling flow path 83 through a hole penetrating the flow path base material 45. Therefore, the flow path 49 tends to be long.

(2) When viewed in the direction in which the first coupling pipe 81 extends, the second welding region A2 is located at a position that does not overlap the first coupling pipe 81.

The flow path unit 28 may be manufactured by welding the second flow path member 47 to the flow path base material 45 after the first flow path member 46 is welded thereto. In this case, the second flow path member 47 is welded to the flow path base material 45 in a state where the first flow path member 46 welded to the flow path base material 45 is installed. Therefore, in a case in which the second welding region A2 is located at a position that overlaps the first coupling pipe 81 when viewed in the direction in which the first coupling pipe 81 extends, the second flow path member 47 will be welded to the second welding region A2 in a state where the tip of the first coupling pipe 81 is installed. In a state where the tip of the first coupling pipe 81 is installed, it is difficult to stabilize the posture during welding. According to the above configuration, the second flow path member 47 can be welded to the flow path base material 45 in a state where the first opposite surface 74 is installed. Therefore, the posture during welding is easily stabilized.

(3) When viewed in the direction in which the first coupling pipe 81 extends, the second welding region A2 is located inside an outer shape of the first flow path member 46.

According to the above configuration, when the second flow path member 47 is welded to the flow path base material 45 in a state where the first flow path member 46 welded to the flow path base material 45 is installed, the installation area is larger. Therefore, when the second flow path member 47 is welded to the second welding region A2 in a state where the first flow path member 46 welded to the flow path base material 45 is installed, the posture is easily stabilized. That is, the posture during welding is more easily stabilized as compared with the case where the second welding region A2 is located outside the outer shape of the first flow path member 46.

(4) The second flow path member 47 has the second welding surface 75, the second opposite surface 76, and the second coupling pipe 82. The second coupling flow path 84, which is a portion of the flow path 49, opens in the second coupling pipe 82. The second coupling flow path 84 communicates with the second relay flow path 62.

Since the second coupling pipe 82 extends from the second opposite surface 76 of the second flow path member 47, the second coupling pipe 82 is located to extend from the second surface 52 defining the second relay flow path 62 in the flow path base material 45. When the second coupling pipe 82 is located to extend from the second surface 52 defining the second relay flow path 62, the flow path 49 becomes shorter than when the second coupling pipe 82 is located to extend from the first surface 51. Therefore, according to the above configuration, the pressure loss in the flow path 49 is reduced.

(5) The elastic member 91 is pressed from the second flow path member 47 toward the flow path base material 45. Specifically, the attachment portion 92 is pressed from the second flow path member 47 toward the flow path base material 45. Accordingly, the elastic member 91 is compressed by being pressed from the second flow path member 47 toward the flow path base material 45. Therefore, when the second flow path member 47 is welded to the flow path base material 45, the elastic member 91 absorbs the looseness between the second flow path member 47 and the flow path base material 45. Therefore, according to the above configuration, welding quality is improved.

(6) The displacement shaft 94 is inserted into the second flow path member 47, and the insertion port 77 communicating with the accommodation chamber 63 is open.

According to the above configuration, since the displacement shaft 94 protrudes from the second flow path member 47, the elastic member 91 can be displaced by operating the displacement shaft 94.

(7) The elastic member 91 closes the second relay flow path 62 by being pressed such that the displacement portion 93 comes into contact with the flow path base material 45.

According to the above configuration, the second relay flow path 62 can be opened and closed by displacing the displacement portion 93.

(8) The flow path unit 28 includes the operating mechanism 87 that operates the plurality of displacement shafts 94 such that the plurality of elastic members 91 open the plurality of second relay flow paths 62, respectively.

According to the above configuration, the operating mechanism 87 can open the plurality of second relay flow paths 62 all at once.

### Modification Example

The above embodiment can be modified and implemented as follows. The above embodiment and the following modification example can be implemented in combination with each other unless there is a technical contradiction.

As illustrated in FIG. 20, the second flow path member 47 may have the second coupling pipe 82. The second coupling pipe 82 extends from the second opposite surface 76. That is, the second coupling pipe 82 is located to extend from the second surface 52. The second coupling flow path 84 communicates with the second relay flow path 62. In this modification example, one relay port is open in the flow path base material 45. The first relay flow path 59 and the second relay flow path 62 communicate with each other through the relay port. In this case, the flow path 49 becomes shorter than when the second coupling pipe 82 is located to extend from the first surface 51. Therefore, the pressure loss in the flow path 49 is reduced.

In the flow path unit 28, the first flow path member 46 may be welded to the flow path base material 45 after the second flow path member 47 is welded. The order of welding the flow path member with respect to the flow path base material 45 may be appropriately changed.

The liquid ejected by the head 22 is not limited to ink and may be a liquid material in which particles of a functional material are dispersed or mixed in the liquid, for example. For example, the head 22 may eject a liquid material containing a material such as an electrode material or a pixel material used in the manufacture of liquid crystal displays, electroluminescent displays, and surface emission displays in a dispersed or dissolved form.

### Technical Ideas

Hereinafter, the technical ideas and the operational effects understood from the above-described embodiment and modification example will be described.

(A) Provided is a flow path unit that constitutes a flow path through which a liquid flows, the flow path unit including: a flow path base material absorbent to laser light; and a flow path member that is a plate material transparent to laser light and is welded to the flow path base material, in which the flow path base material has a first surface and a second surface that is a surface opposite to the first surface, a welding region to be welded to the flow path member is formed at the first surface, a relay flow path that is a portion of the flow path is defined by welding the flow path member to the welding region, the flow path member has a welding surface welded to the welding region, an opposite surface that is a surface opposite to the welding surface, and a coupling pipe that extends from the opposite surface, a coupling flow path that is a portion of the flow path opens in the coupling pipe, and the coupling flow path communicates with the relay flow path.

Since the coupling pipe extends from the opposite surface of the flow path member, the coupling pipe is located to extend from the first surface defining the relay flow path in the flow path base material. When the coupling pipe is located to extend from the first surface defining the relay flow path, the flow path becomes shorter than when the coupling pipe is located to extend from the second surface. Therefore, according to the above configuration, the pressure loss in the flow path is reduced. When the coupling pipe is located to extend from the second surface, the relay flow path defined by the first surface will be coupled to the coupling flow path through a hole penetrating the flow path base material. Therefore, the flow path tends to be long.

(B) In the flow path unit, the flow path member may be a first flow path member, the welding region may be a first welding region, the relay flow path may be a first relay flow path, the flow path unit may further include a second flow path member that is a plate material transparent to laser light and is welded to the flow path base material, a second welding region to be welded to the second flow path member may be formed at the second surface, a second relay flow path that is a portion of the flow path may be defined by welding the second flow path member to the second welding region, and the second welding region may be located at a position that does not overlap the coupling pipe when viewed in a direction in which the coupling pipe extends.

The flow path unit may be manufactured by welding the second flow path member to the flow path base material after the first flow path member is welded thereto. In this case, the second flow path member is welded to the flow path base material in a state where the first flow path member welded to the flow path base material is installed. Therefore, in a case in which the second welding region is located at a position that overlaps the coupling pipe when viewed in the direction in which the coupling pipe extends, the second flow path member will be welded to the second welding region in a state where the tip of the coupling pipe is installed. In a state where the tip of the coupling pipe is installed, it is difficult to stabilize the posture during welding. According to the above configuration, the second flow path member can be welded to the flow path base material in a state where the opposite surface is installed. Therefore, the posture during welding is easily stabilized.

(C) In the flow path unit, the second welding region may be located inside an outer shape of the first flow path member when viewed in the direction in which the coupling pipe extends.

According to the above configuration, when the second flow path member is welded to the flow path base material in a state where the first flow path member welded to the flow path base material is installed, the installation area is larger. Therefore, when the second flow path member is welded to the second welding region in a state where the first flow path member welded to the flow path base material is installed, the posture is easily stabilized. That is, the posture during welding is more easily stabilized as compared with the case where the second welding region is located outside the outer shape of the first flow path member.

(D) In the flow path unit, the flow path member may be a first flow path member, the welding region may be a first welding region, the relay flow path may be a first relay flow path, the flow path unit may further include a second flow path member that is a plate material transparent to laser light and is welded to the flow path base material, a second welding region to be welded to the second flow path member may be formed at the second surface, a second relay flow path that is a portion of the flow path may be defined by welding the second flow path member to the second welding region, and the second welding region may be located inside an outer shape of the first flow path member when viewed in a direction in which the coupling pipe extends.

The flow path unit may be manufactured by welding the second flow path member to the flow path base material after the first flow path member is welded thereto. In this case, the second flow path member is welded to the flow path base material in a state where the first flow path member welded to the flow path base material is installed. According to the above configuration, when the second flow path member is welded to the flow path base material in a state where the first flow path member welded to the flow path base material is installed, the installation area is larger. Therefore, when the second flow path member is welded to the second welding region in a state where the first flow path member welded to the flow path base material is installed, the posture is easily stabilized. That is, the posture during welding is more easily stabilized as compared with the case where the second welding region is located outside the outer shape of the first flow path member.

(E) In the flow path unit, the welding surface may be a first welding surface, the opposite surface may be a first opposite surface, the coupling pipe may be a first coupling pipe, the coupling flow path may be a first coupling flow path, the second flow path member may have a second welding surface welded to the second welding region, a second opposite surface that is a surface opposite to the second welding surface, and a second coupling pipe that extends from the second opposite surface, a second coupling flow path that is a portion of the flow path may open in the second coupling pipe, and the second coupling flow path may communicate with the second relay flow path.

Since the second coupling pipe extends from the second opposite surface of the second flow path member, the second coupling pipe is located to extend from the second surface defining the second relay flow path in the flow path base material. When the second coupling pipe is located to extend from the second surface defining the second relay flow path, the flow path becomes shorter than when the second coupling pipe is located to extend from the first surface. Therefore, according to the above configuration, the pressure loss in the flow path is reduced.

(F) The flow path unit may further include a displacement section having an elastic member elastically deformed, in which an accommodation chamber in which the displacement section is accommodated is defined by welding the second flow path member to the second welding region, the elastic member is pressed from the second flow path member toward the flow path base material, and the second relay flow path extends between the flow path base material and the elastic member.

The elastic member is compressed by being pressed from the second flow path member toward the flow path base material. Therefore, when the second flow path member is welded to the flow path base material, the elastic member absorbs the looseness between the second flow path member and the flow path base material. Therefore, according to the above configuration, welding quality is improved.

(G) In the flow path unit, the displacement section may have a displacement shaft extending from the elastic member, and the displacement shaft may be inserted into the second flow path member, and an insertion port communicating with the accommodation chamber may be open. According to the above configuration, since the displacement shaft protrudes from the second flow path member, the elastic member can be displaced by operating the displacement shaft.

(H) In the flow path unit, the elastic member may have an attachment portion attached to the flow path base material and a displacement portion displaced with respect to the flow path base material, and close the second relay flow path by being pressed such that the displacement portion comes into contact with the flow path base material. According to the above configuration, the second relay flow path can be opened and closed by displacing the displacement portion.

(I) In the flow path unit, the displacement section may have a displacement shaft extending from the elastic member, and the displacement shaft may be inserted into the second flow path member, and an insertion port communicating with the accommodation chamber may be open.

According to the above configuration, since the pressing member protrudes from the second flow path member, the displacement shaft can be operated. The elastic member can be displaced by operating the displacement shaft. That is, the second relay flow path can be opened and closed by operating the displacement shaft.

(J) In the flow path unit, the second relay flow path may be one of a plurality of second relay flow paths, and the displacement section may be one of a plurality of displacement sections, the elastic member may be one of a plurality of elastic members, the displacement shaft may be one of a plurality of displacement shafts, and the flow path unit may further include an operating mechanism that operates the plurality of displacement shafts such that the plurality of elastic members open the plurality of second relay flow paths, respectively. According to the above configuration, the operating mechanism can open the plurality of second relay flow paths all at once.

(K) Provided is a liquid ejecting apparatus including: a head that ejects a liquid; and a flow path unit that constitutes a flow path through which a liquid supplied to the head flows, in which the flow path unit has a flow path base material absorbent to laser light, and a flow path member that is a plate material transparent to laser light and is welded to the flow path base material, the flow path base material has a first surface and a second surface that is a surface opposite to the first surface, a welding region to be welded to the flow path member is formed at the first surface, a relay flow path that is a portion of the flow path is defined by welding the flow path member to the welding region, the flow path member has a welding surface welded to the welding region, an opposite surface that is a surface opposite to the welding surface, and a coupling pipe that extends from the opposite surface, a coupling flow path that is a portion of the flow path opens in the coupling pipe, and the coupling flow path communicates with the relay flow path. According to the above configuration, the same effects as the above-described flow path unit can be obtained.

(L) Provided is a method of manufacturing a flow path unit including a flow path base material and a flow path member, the flow path base material being absorbent to laser light and having a first surface and a second surface that is a surface opposite to the first surface, the flow path member being a plate material transparent to laser light and having a welding surface, an opposite surface opposite to the welding surface, and a coupling pipe that extends from the opposite surface and has a coupling flow path opened, the method including: bringing the welding surface into contact with the first surface; and welding the flow path member to the flow path base material such that a relay flow path communicating with the coupling flow path is defined by irradiating a welding region, which is a region in contact with the welding surface on the first surface, with laser light. According to the above manufacturing method, the above-described flow path unit can be manufactured.

(M) In the method of manufacturing the flow path unit, the flow path member may be a first flow path member, the welding region may be a first welding region, the relay flow path may be a first relay flow path, the method of manufacturing the flow path unit may further include: bringing a second welding surface of a second flow path member into contact with the second surface, the second flow path member being a plate material transparent to laser light and having the second welding surface and a second opposite surface that is a surface opposite to the second welding surface; and welding the second flow path member to the flow path base material by irradiating a second welding region located at a position that does not overlap with the coupling pipe when viewed in a direction in which the coupling pipe extends with laser light, the second welding region being a region in contact with the second welding surface on the second surface. According to the above manufacturing method, the above-described flow path unit can be manufactured.

(N) The method of manufacturing the flow path unit may further include: locating, on the second surface, a displacement section having an elastic member elastically deformed; bringing the second welding surface into contact with the second surface in a state where the elastic member is pressed from the second flow path member toward the flow path base material; and welding the second flow path member to the flow path base material such that a second relay flow path extending between the flow path base material and the elastic member is defined by irradiating the second welding region with laser light. According to the above manufacturing method, the above-described flow path unit can be manufactured.

What is claimed is:

1. A flow path unit that constitutes a flow path through which a liquid flows, the flow path unit comprising:
a flow path base material absorbent to laser light; and
a flow path member that is transparent to laser light and is welded to the flow path base material, wherein
the flow path base material has a first surface and a second surface that is a surface opposite to the first surface,
a welding region to be welded to the flow path member is formed at the first surface,
a relay flow path that is a portion of the flow path is defined by welding the flow path member to the welding region,
the flow path member has
a welding surface welded to the welding region,
an opposite surface that is a surface opposite to the welding surface, and
a coupling pipe that extends from the opposite surface,
a coupling flow path that is a portion of the flow path opens in the coupling pipe, and
the coupling flow path communicates with the relay flow path.

2. The flow path unit according to claim 1, wherein
the flow path member is a first flow path member,
the welding region is a first welding region,
the relay flow path is a first relay flow path,
the flow path unit further comprises a second flow path member that is transparent to laser light and is welded to the flow path base material,
a second welding region to be welded to the second flow path member is formed at the second surface,
a second relay flow path that is a portion of the flow path is defined by welding the second flow path member to the second welding region, and
the second welding region is located at a position that does not overlap the coupling pipe when viewed in a direction in which the coupling pipe extends.

3. The flow path unit according to claim 2, wherein
the second welding region is located inside an outer shape of the first flow path member when viewed in the direction in which the coupling pipe extends.

4. The flow path unit according to claim 1, wherein
the flow path member is a first flow path member,
the welding region is a first welding region,
the relay flow path is a first relay flow path,
the flow path unit further comprises a second flow path member that is transparent to laser light and is welded to the flow path base material,
a second welding region to be welded to the second flow path member is formed at the second surface,
a second relay flow path that is a portion of the flow path is defined by welding the second flow path member to the second welding region, and
the second welding region is located inside an outer shape of the first flow path member when viewed in a direction in which the coupling pipe extends.

5. The flow path unit according to claim 2, wherein
the welding surface is a first welding surface,
the opposite surface is a first opposite surface,
the coupling pipe is a first coupling pipe,
the coupling flow path is a first coupling flow path,
the second flow path member has
a second welding surface welded to the second welding region,
a second opposite surface that is a surface opposite to the second welding surface, and
a second coupling pipe that extends from the second opposite surface,
a second coupling flow path that is a portion of the flow path opens in the second coupling pipe, and
the second coupling flow path communicates with the second relay flow path.

6. The flow path unit according to claim 2, further comprising a displacement section having an elastic member elastically deformed, wherein
an accommodation chamber in which the displacement section is accommodated is defined by welding the second flow path member to the second welding region,
the elastic member is pressed from the second flow path member toward the flow path base material, and
the second relay flow path extends between the flow path base material and the elastic member.

7. The flow path unit according to claim 6, wherein
the displacement section has a displacement shaft extending from the elastic member, and
the displacement shaft is inserted into the second flow path member, and an insertion port communicating with the accommodation chamber is open in the second flow path member.

8. The flow path unit according to claim 6, wherein
the elastic member has an attachment portion attached to the flow path base material and a displacement portion displaced with respect to the flow path base material, and the elastic member closing the second relay flow path by being pressed such that the displacement portion comes into contact with the flow path base material.

9. The flow path unit according to claim 8, wherein
the displacement section has a displacement shaft extending from the elastic member, and
the displacement shaft is inserted into the second flow path member, and an insertion port communicating with the accommodation chamber is open in the second flow path member.

10. The flow path unit according to claim 9, wherein
the second relay flow path is one of a plurality of second relay flow paths,
the displacement section is one of a plurality of displacement sections,
the elastic member is one of a plurality of elastic members,
the displacement shaft is one of a plurality of displacement shafts, and
the flow path unit further comprises an operating mechanism that operates the plurality of displacement shafts such that the plurality of elastic members open the plurality of second relay flow paths, respectively.

11. A liquid ejecting apparatus comprising:
a head that ejects a liquid; and
a flow path unit that constitutes a flow path through which a liquid supplied to the head flows, wherein
the flow path unit has
a flow path base material absorbent to laser light, and
a flow path member that is transparent to laser light and is welded to the flow path base material,
the flow path base material has a first surface and a second surface that is a surface opposite to the first surface,
a welding region to be welded to the flow path member is formed at the first surface,
a relay flow path that is a portion of the flow path is defined by welding the flow path member to the welding region,
the flow path member has
a welding surface welded to the welding region,
an opposite surface that is a surface opposite to the welding surface, and
a coupling pipe that extends from the opposite surface,
a coupling flow path that is a portion of the flow path opens in the coupling pipe, and
the coupling flow path communicates with the relay flow path.

12. A method of manufacturing a flow path unit including a flow path base material and a flow path member, the flow path base material being absorbent to laser light and having a first surface and a second surface that is a surface opposite to the first surface,
the flow path member being transparent to laser light and having a welding surface, an opposite surface opposite to the welding surface, and a coupling pipe that extends from the opposite surface and has a coupling flow path opened, the method comprising:
bringing the welding surface into contact with the first surface; and
welding the flow path member to the flow path base material such that a relay flow path communicating with the coupling flow path is defined by irradiating a welding region, which is a region in contact with the welding surface on the first surface, with laser light.

13. The method of manufacturing the flow path unit according to claim 12, wherein
the flow path member is a first flow path member,
the welding region is a first welding region,
the relay flow path is a first relay flow path,
the method of manufacturing the flow path unit further comprises:
bringing a second welding surface of a second flow path member into contact with the second surface, the second flow path member being transparent to laser light and having the second welding surface and a second opposite surface that is a surface opposite to the second welding surface; and
welding the second flow path member to the flow path base material by irradiating a second welding region located at a position that does not overlap with the coupling pipe when viewed in a direction in which the coupling pipe extends with laser light, the second welding region being a region in contact with the second welding surface on the second surface.

14. The method of manufacturing the flow path unit according to claim 13, further comprising:
locating, on the second surface, a displacement section having an elastic member elastically deformed;
bringing the second welding surface into contact with the second surface in a state where the elastic member is pressed from the second flow path member toward the flow path base material; and
welding the second flow path member to the flow path base material such that a second relay flow path extending between the flow path base material and the elastic member is defined by irradiating the second welding region with laser light.
